(19) United States
(12) Patent Application Publication
(10) Pub. No.: US 2025/0360451 A1
(43) Pub. Date: Nov. 27, 2025

(54) A SYSTEM FOR CAPTURE OF CARBON DIOXIDE

(71) Applicant: SHELL USA, INC., Houston, TX (US)

(72) Inventors: Sayee Prasaad BALAJI, Amsterdam (NL); Timothy Michael NISBET, Amsterdam (NL)

(21) Appl. No.: 18/865,492

(22) PCT Filed: May 9, 2023
(86) PCT No.: PCT/EP2023/062202

§ 371 Date: Nov. 13, 2024

(30) Foreign Application Priority Data
May 18, 2022 (EP) 22173925.3

(51) Int. Cl. B01D 53/04

(52) U.S. Cl. CPC B01D 53/0446; B01D 53/0438; B01D 2257/504; B01D 2259/40086; B01D 2259/40096; B01D 2259/4062

(57) ABSTRACT

A system for capture of CO₂ from a gaseous CO₂-containing stream is provided. The system comprises a plurality of first inlets for stream; a plurality of first outlets for a treated stream having a reduced CO₂-concentration; and a plurality of supported sorbent materials between the first inlets and outlets allowing a first flow path (A) during a CO₂-adsorption phase. Each supported sorbent material possesses a first side for receiving stream and a second side from which stream exits. Optionally, the system comprises a second inlet for a desorption fluid; a second outlet; a sealer for closing the first inlets and outlets during a CO₂-desorption phase creating a second flow path (B) for fluid comprising desorbed CO₂ through adjacent supported sorbent materials to the second outlet wherefrom a CO₂-enriched stream can exit.

The present invention relates to a system and process for the capture of carbon dioxide (CO₂) from a gaseous CO₂-containing stream such as air or from a specially conditioned atmosphere such as one that includes exhaust flue gases from industrial processes.

Direct air capture (DAC) of carbon dioxide from the air has been proposed as one way of addressing human induced climate change. Current estimates place global levels of CO₂ in the atmosphere at around 420 parts per million. This is expected to rise to around 900 parts per million by the end of the 21st century. Hence, DAC represents one of a range of technologies that can be employed to reduce the environmental impact of greenhouse gases like CO₂ and help the transition to a low carbon global economy.

Typical DAC systems take large quantities of air (or other conditioned gaseous atmosphere) which is pumped as a (feed) stream through a unit that contains a sorbent substance that removes the CO₂ from the stream under ambient conditions. Over time the sorbent becomes loaded with captured CO₂. Next, the captured CO₂ in the sorbent is extracted from the sorbent in a regeneration/desorption step. Desorption may involve thermal or chemical processes depending upon the type of sorbent material that is selected for use in the DAC. For example, amine-functionalised resins such as polyethyleneimines (PEI) can serve as effective sorbents that are regenerated with steam at temperatures of above 50° C., typically up to or around 130° C. Upon regeneration the captured CO₂ is released from the sorbent and can be used to manufacture sustainable fuels, specialty chemicals, in food and beverage production or in carbon capture and sequestration (CCS) in order to create a net negative carbon process.

The sorbent is typically arranged in assemblies of a plurality of monoliths or beds. Each monolith or bed is formed of a highly porous substrate, such as an alumina or silica, having a high proportion of a sorbent such as an inorganic carbonate or an amine on its available surfaces to facilitate CO₂ adsorption.

Several publications on DAC systems have been made in the recent past.

A problem of known DAC systems is the occurrence of contamination with air of the captured CO₂ in the desorption step. DAC is a capital-intensive process due to the necessity to process large amount of air. The air is typically moved by fans and the energy consumption is proportional to the pressure drop. Any pressure drop above a few mbar will lead to very high energy cost.

WO 2016/050944 A1 proposes the use of a bed of adsorbent particles in a vessel. However, this will lead to a high pressure drop.

EP 3 482 813 A1 proposes to minimize the pressure drop by using a radial (or ring-shaped) bed design. However, this results in a very large dead volume, which means that the CO₂ removed during desorption is contaminated with high levels of air.

Another approach, as proposed in WO 2021/239747 A1, is to use parallel adsorber elements. However, this requires large amounts of stripping gas in the desorption step to achieve a high CO₂ concentration. Also, the parallel adsorber elements have to be specifically manufactured.

WO 2021/239748 A1 discloses a method for the regeneration of sorbents for usage in a cyclic adsorption-desorption process for the capture of CO₂ from atmospheric air and to the use of such a method for direct air capture (DAC).

A further approach is to use monoliths, such as proposed in e.g. U.S. Pat. No. 10,512,880. These monoliths have the advantage of low pressure drop and low dead volume, but are generally more expensive to produce than particles such as pellets, tablets or extrudates.

U.S. Pat. No. 10,427,086 describes a gas separation unit for the separation of CO₂ in a cyclic adsorption/desorption process whilst using a loose particulate sorbent material arranged in stacked layers. This has the advantage of low pressure drop, but results in contamination with air of the captured CO₂ in the desorption/regeneration step. It is an object of the present invention to solve, minimize or at least reduce one or more of the above problems.

It is a further object of the present invention to provide an alternative system and process for the capture of CO₂ from a CO₂-containing gas stream, whilst achieving a low-pressure drop and a reduced contamination with air of the captured CO₂ in the desorption step.

One or more of the above or other objects may be achieved by the present invention by providing a system for capture of carbon dioxide (CO₂) from a gaseous CO₂-containing stream, the system at least comprising:
a plurality of first inlets for a gaseous CO₂-containing stream;
a plurality of first outlets for a treated stream having a reduced CO₂-concentration compared to the gaseous CO₂-containing stream;
a plurality of supported sorbent materials placed between the plurality of first inlets and the plurality of first outlets allowing a first flow path therethrough for the gaseous CO₂-containing stream during a CO₂-adsorption phase, wherein each supported sorbent material possesses a first side that during the CO₂-adsorption phase can receive the gaseous CO₂-containing stream and a second side from which a treated gaseous stream having a reduced CO₂-concentration can exit the supported sorbent material;
optionally, a second inlet for a desorption fluid;
a second outlet for a CO₂-enriched stream;
a sealer comprising a pair of doors or plates which can close the plurality of first inlets and the plurality of first outlets during a CO₂-desorption phase thereby creating a second flow path for a fluid comprising desorbed CO₂ through a plurality of adjacent supported sorbent materials to the second outlet from which a CO₂-enriched stream can exit.

It has been surprisingly found according to the present invention that by using a (removable) sealer a low-pressure drop and a reduced contamination with air can be achieved for the captured CO₂ in the desorption step.

A further advantage of the present invention is that only low velocities of the CO₂-enriched stream are required, thereby reducing the amount of desorption fluid when applied.

The person skilled in the art will readily understand that the sorbent materials as used in the supported sorbent materials can be widely chosen. The sorbent can be any described in the prior art, such as an inorganic carbonate (e.g. potassium carbonate) or an amine. Suitable sorbents are described in e.g. X. Shi et al, Sorbents for the Direct Capture of CO₂ from Ambient Air, Angew. Chem. Int. Ed. 2020, 59, 2-25.

Typically, the supported sorbent materials are supported within a support bed or block. The support beds or blocks are comprised of a porous material. As mere examples, the sorbent can be supported on a substrate such as an extruded mesoporous alumina (e.g. α or γ-alumina) or silica substrate.

Preferably, the supported sorbent materials comprise sorbent particles supported within a bed. Typically, the sorbent particles have a size in the range of from 0.5-10 mm, preferably 1-3 mm. Further it is preferred that the supported sorbent materials have a bed depth of from 1 to 20 cm, preferably from 2 to 10 cm.

Furthermore, it is preferred that the supported sorbent materials are closed at the faces that are substantially perpendicular to the flow direction of the first flow path. This allows that the first and second flow paths through the supported sorbent materials pass only through the supported sorbent materials between the first and second sides. Dependent on the orientation of the DAC system, these closed faces may be at different positions of the supported sorbent materials. As a mere example, if the first and second flow paths are substantially vertical, then the closed faces are at the top and bottom of the supported sorbent materials. In this case, the first and second flow paths through the supported sorbent materials would pass only through the sides of the supported sorbent materials (even though the first (and second) flow path(s) as a whole would still be substantially vertical).

Also, preferably, the supported sorbent materials have converging (i.e. tapered) first inlets. Further it is preferred that the first inlets of the supported sorbent materials are slanted. This allows that the flow in the first inlets during the CO₂ adsorption phase is substantially parallel to the bed. Also, it allows the flow in the first inlets during the CO₂ adsorption phase to have a velocity that is close to constant along the whole of first inlets; typically, the velocities do not vary by more than 10%.

Further, it is preferred that the supported sorbent materials have diverging first outlets. Also, it is preferred that the first outlets of the supported sorbent materials are slanted.

According to an especially preferred embodiment according to the present invention, the system comprises at least 5 supported sorbent materials, preferably at least 10, more preferably at least 20.

As mentioned above, the plurality of supported sorbent materials placed between the plurality of first inlets and the plurality of first outlets allow a first flow path for the gaseous CO₂-containing through the supported sorbent materials stream during a CO₂-adsorption phase. This first flow path during the CO₂-adsorption phase runs from the first inlet to the first outlet of each separate supported sorbent material. The first flow paths in the separate supported sorbent materials run typically substantially parallel.

During the CO₂-adsorption phase each supported sorbent material possesses a first side that can receive the gaseous CO₂-containing stream and a second side from which a treated gaseous stream having a reduced CO₂-concentration can exit the supported sorbent material.

The sealer as used in the system according to the present invention comprises a pair of doors or plates and it can close the plurality of first inlets and the plurality of first outlets during a CO₂-desorption phase thereby creating a second flow path for a fluid comprising desorbed CO₂ through a plurality of adjacent supported sorbent materials and to the second outlet. From this second outlet, a CO₂-enriched stream can exit the system.

It is of note that the second flow path through the plurality of adjacent supported sorbent materials during the desorption phase is ‘in series’. This means that the second flow paths run through a plurality of adjacent supported sorbent materials before reaching the second outlet for the CO₂ enriched stream. Preferably, the second flow paths run through at least 5 supported sorbent materials, preferably at least 10, more preferably at least 20.

Optionally, (but preferably) the system according to the present invention comprises a second inlet for the desorption fluid to be introduced in the desorption phase to create or assist the flow through the second flow path from the second inlet through the plurality of adjacent supported sorbent materials to the second outlet.

Instead, or in addition, the system may comprise a heater for heating the supported sorbent materials. Preferably, during the desorption phase, the heater starts with heating the supported sorbent materials placed the furthest away from the second outlet, then progressively heating supported sorbent materials placed closer to the second outlet. Preferably, electrical heating is used; also, it is preferred that the electricity used from the electrical heating is generated by renewable power.

According to a further preferred embodiment of the system according to the present invention, the system further comprises a filter placed upstream of the plurality of first inlets when in CO₂ adsorption phase. Typically, the filter can filter out particles having a size of at least 1 micron (which might otherwise foul the supported sorbent material).

In a further aspect the present invention provides a process for capture of carbon dioxide (CO₂) from a gaseous CO₂-containing stream, in particular whilst using the system according to the present invention, the process at least comprising the steps of:
(a) providing a gaseous CO₂-containing stream;
(b) introducing the gaseous CO₂-containing stream via a plurality of first inlets;
(c) passing the gaseous CO₂-containing stream via a first flow path through the supported sorbent materials to a plurality of first outlets thereby adsorbing CO₂ from the CO₂-containing stream;
(d) removing a treated stream from the first outlets having a reduced CO₂-concentration compared to the gaseous CO₂-containing stream;
(e) sealing the plurality of first inlets and first outlets with a pair of doors or plates thereby creating a second flow path for a fluid comprising desorbed CO₂ through a plurality of adjacent supported sorbent materials to a second outlet;
(f) desorbing the plurality of adjacent supported sorbent materials thereby releasing CO₂ adsorbed to the supported sorbent materials and obtaining a CO₂-enriched stream;
(g) removing the CO₂-enriched stream obtained in step (f) from the second outlet.

In step (a) of the process according to the present invention, a gaseous CO₂-containing stream is provided. The CO₂-containing stream is not particularly limited and will typically have a relatively low CO₂-concentration (of between 300 ppmv-2 vol. % CO₂). Generally, the CO₂-containing stream will be air.

In step (b) of the process according to the present invention, the gaseous CO₂-containing stream is introduced in the system via a plurality of first inlets.

In step (c) of the process according to the present invention, the gaseous CO₂-containing stream is passed via a first flow path through the supported sorbent materials to a plurality of first outlets thereby adsorbing CO₂ from the CO₂-containing stream. This first flow path during the CO₂-adsorption phase runs from the first inlet to the first outlet of each separate supported sorbent material. The first flow paths in the separate supported sorbent materials run typically substantially parallel. During the CO₂-adsorption phase each supported sorbent material possesses a first side that can receive the gaseous CO₂-containing stream and a second side from which a treated gaseous stream having a reduced CO₂-concentration can exit the supported sorbent material.

It will be appreciated that very large amounts of gas (e.g. air) need to be passed through the supported sorbent materials to capture sufficient CO₂. To avoid excessive power consumption, it is also necessary to operate with low gas flow velocities, which typically limits velocity in the supported sorbent material to below 10 m/s, more typically below 5 m/s.

In step (d) of the process according to the present invention, a treated stream is removed from the first outlets having a reduced CO₂-concentration compared to the gaseous CO₂-containing stream. Typically, the treated stream has a CO₂-concentration of at most 200 ppmv CO₂.

In step (e) of the process according to the present invention, the plurality of first inlets and first outlets are sealed thereby creating a second flow path for a fluid comprising desorbed CO₂ through a plurality of adjacent supported sorbent materials to a second outlet.

As mentioned earlier, the sealing according to the present invention is performed by a pair of doors or plates.

The timing of the sealing will typically be determined dependent on e.g. a predetermined time of passing the gaseous CO₂-containing stream through the supported sorbent materials in step (c), after a predetermined amount of the CO₂-containing stream has passed or when the supported sorbent materials reach a predetermined CO₂ saturation level. Typically, at the time of sealing, the sorbent material will be loaded with CO₂ to between 40 to 100% of its CO₂-saturation capacity, more typically 70 to 90%.

In step (f) of the process according to the present invention, the plurality of adjacent supported sorbent materials are desorbed, thereby releasing CO₂ adsorbed to the supported sorbent materials and obtaining a CO₂-enriched stream.

The person skilled in the art will readily understand that the desorbing in step (f) is not particularly limited and can be performed in many ways. According to an especially preferred embodiment according to the present invention, the desorbing in step (f) comprises passing a stream of a desorption fluid via the second flow path from a second inlet through the plurality of adjacent supported sorbent materials to the second outlet. A suitable desorption fluid is steam. If steam is used as the desorption fluid, then it will typically have a temperature up to 130° C. Preferably, the stream of desorption fluid in step (f) has a pressure of between 0.5-1.5 bara, preferably between 0.9-1.1 bara.

It is preferred according to the present invention that the second flow path during desorbing in step (f) is through at least 5 subsequent supported sorbent materials in series, preferably at least 10, more preferably at least 20. Irrespective of whether a desorption fluid is used (that would be fed via the second inlet), there will be a second flow path through a plurality of adjacent supported sorbent materials to the second outlet (i.e. through several supported sorbent materials ‘in series’). It has been surprisingly shown by the present invention that by using the second flow path through a plurality of adjacent supported sorbent materials to the second outlet in series, less contamination of the desorbed CO₂ with any air trapped in the supported sorbent materials occurs.

According to another preferred embodiment, the desorbing in step (f) comprises heating the supported sorbent materials, preferably starting with the supported sorbent materials placed the furthest away from the second outlet, progressively followed by supported sorbent materials placed closer to the second outlet. By heating in this manner, the second flow path is created. It is to be noted that this heating can take place instead of or in addition to the use of a desorption fluid such as steam. If heating is used, then this is preferably using electrical heating generated by renewable power. The heating is typically to a temperature in the range of 60-130° C.

During the desorbing in step (f), the flow is typically lower than in the adsorption phase in step (c). Typically, the flow velocity is in the range of 0.1-1.0 m/s.

In step (g) of the process according to the present invention, the CO₂-enriched stream obtained in step (f) is removed from the second outlet. Typically, the CO₂-enriched stream has a CO₂ concentration of at least 90 vol. % on a dry basis (i.e. excluding steam if used as desorption fluid), preferably at least 99 vol. % on a dry basis. The person skilled in the art will readily understand that the CO₂-enriched stream can be used for many purposes, such as subsurface storage, conversion into products, etc.

The adsorption/desorption sequence of steps (a)-(g) can be made cyclic. To this end, the present invention preferably further comprises the steps:
(h) undoing the sealing of the plurality of first inlets and first outlets;
(i) repeating steps (a)-(h) multiple times.

Hereinafter the present invention will be further illustrated by the following non-limiting drawings. Herein shows:

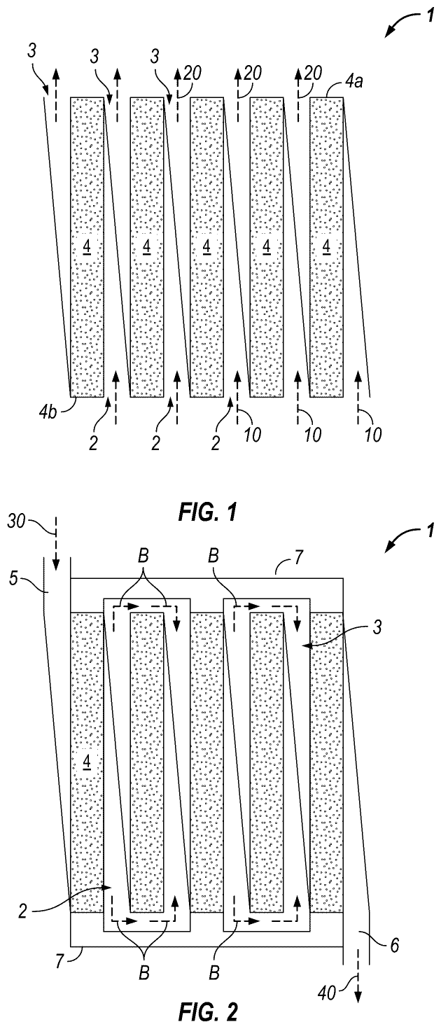

FIG. 1 a schematic representation of a DAC system according to the present invention in adsorption phase;

FIG. 2 a schematic representation of a first embodiment of the DAC system according to FIG. 1 in desorption phase;

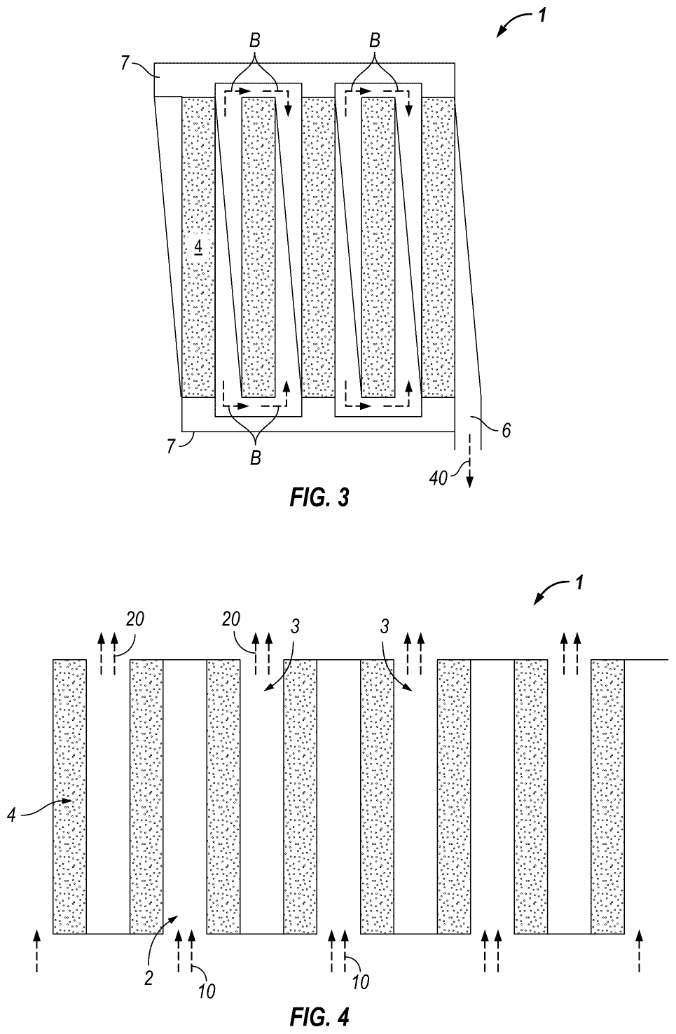

FIG. 3 a schematic representation of a second embodiment of the DAC system according to FIG. 1 in desorption phase;

FIG. 4 a schematic representation of a further embodiment of a DAC system according to the present invention in adsorption phase; and

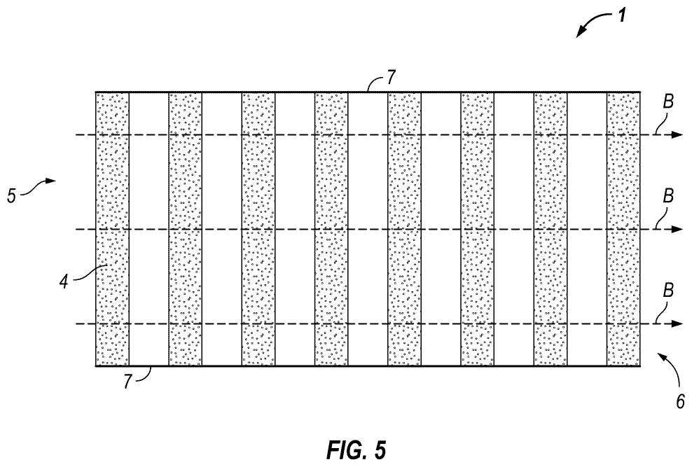

FIG. 5 a schematic representation of the DAC system according to FIG. 4 in desorption phase.

In this respect it is noted that the orientation of the DAC system may be varied and may be such that the first flow path A is substantially horizontal, substantially vertical or at an angle. In case that the first flow path A would be substantially horizontal, then FIGS. 1-5 are top views. In case that the first flow path A would be substantially vertical, then FIGS. 1-5 are side views. Please note that the first flow path A may be parallel (see FIGS. 1-3) or perpendicular (see FIGS. 4-5) to second flow path B.

For the purpose of this description, same reference numbers refer to same or similar components or streams.

The DAC system of FIG. 1, generally referred to with reference number 1, shows a plurality of first inlets 2 for a gaseous CO₂-containing stream 10; a plurality of first outlets 3 for a treated stream 20 having a reduced CO₂-concentration compared to the gaseous CO₂-containing stream 10; a plurality (i.e. five) of supported sorbent materials 4 placed between the plurality of first inlets 2 and the plurality of first outlets 3 allowing a first flow path (A; not shown) therethrough for the gaseous CO₂-containing stream during a CO₂-adsorption phase.

In the embodiment of FIG. 1 the supported sorbent materials 4 comprise sorbent particles supported within a bed. The supported sorbent materials 4 are closed at the faces substantially perpendicular to the flow direction of the first flow path A and the second flow path B. In case FIG. 1 would be a side view, then these faces would be the top 4a and bottom 4b of the supported sorbent materials 4. The supported sorbent materials 4 have converging first inlets 2, which are slanted. Furthermore, the supported sorbent materials 4 have diverging first outlets 3, which are also slanted.

Typically, the system 1 will typically also comprise a filter (not shown) placed upstream of the plurality of first inlets 2 when in CO₂ adsorption phase. This filter avoids that particulate material can enter the system 1.

During use of the system of FIG. 1, a gaseous CO₂-containing stream 10 will be introduced via the plurality of first inlets 2 and pass via the first flow path through the supported sorbent materials 4 to the plurality of first outlets 3 thereby adsorbing CO₂ from the CO₂-containing stream. A treated stream 20 will be removed from the first outlets 3. This treated stream 10 will have a reduced CO₂-concentration compared to the gaseous CO₂-containing stream 10.

After a certain time has passed (or once a CO₂ saturation level for the supported sorbent materials has been obtained), the adsorption phase as shown in FIG. 1 will be ended, and a desorption phase will start. This desorption phase will be illustrated with reference to FIGS. 2 and 3.

FIGS. 2 and 3 show schematic representations of a first and a second embodiment of the DAC system according to FIG. 1 when in desorption phase.

In the embodiment of FIG. 2, the system 1 further comprises a second inlet 5 for a desorption fluid 30 (such as steam) and a second outlet 6 for a CO₂-enriched stream 40. Furthermore, the system comprises a sealer 7 which can close the plurality of first inlets 2 and the plurality of first outlets 3 during the CO₂-desorption phase as shown in FIGS. 2 and 3. The sealer 7 is in the form of a pair of doors or plates and creates a second flow path B for a fluid comprising desorbed CO₂ through the plurality of adjacent supported sorbent materials 4 to the second outlet 6 from which the CO₂-enriched stream 40 can exit. In the embodiment of FIGS. 1-3, the second flow path B (in desorption phase) is substantially parallel to the first flow path A (in adsorption phase); initially, the second flow path B is contrary to the first flow path A, then the same and subsequently contrary again. In an alternative embodiment (not shown), the second flow path B has a direction which is initially the same as the first flow path A (and subsequently contrary, and so on).

After sealing the plurality of first inlets 2 and first outlets 3 by the sealer 7, a second flow path B for desorbed CO₂ is created. The flow path B runs through the plurality of adjacent supported sorbent materials 4 in series to the second outlet 6.

During the desorption phase, the plurality of adjacent supported sorbent materials 4 are desorbed thereby releasing CO₂ adsorbed to the supported sorbent materials 4 and obtaining the CO₂-enriched stream 40. The obtained CO₂-enriched stream 40 is removed from the system 1 via the second outlet 6.

In the embodiment of FIG. 2, the desorbing comprises passing a desorption fluid 30 (e.g. steam) from the second inlet 5 via the second flow path B through the plurality of adjacent supported sorbent materials 4 to the second outlet 6. As can be seen, the second flow path B is through five subsequent supported sorbent materials 4 in series.

In the embodiment of FIG. 3, no second inlet 5 is present. In this case the desorbing takes place by heating the supported sorbent materials 4 (no heating being shown). To this end, first the supported sorbent materials 4 placed the furthest away from the second outlet 6 are heated, progressively followed by heating the supported sorbent materials 4 placed closer to the second outlet 6. This progressive heating of different supported sorbent materials 4 will create the second flow path B. It goes without saying that heating may also be applied in the embodiment of FIG. 2. For the heating, heaters (not shown) are used. Preferably, electrical heating is used, powered by renewable energy.

After the desorption phase has ended, the adsorption/desorption cycle can be repeated.

In FIGS. 4 and 5 a further embodiment of the DAC system according to the present invention is shown. FIG. 4 shows the adsorption phase and FIG. 5 the desorption phase. In this embodiment, the flow path B in the desorption phase is substantially perpendicular to the flow path A (not shown) in the adsorption phase.

### EXAMPLES

### Example 1

The system of FIGS. 1 and 2 was used to illustrate the capture of CO₂ from air, whilst using five, ten and twenty beds of supported sorbent materials (reference number 4 in FIGS. 1 and 2). As supported sorbent materials, sorbent particles supported within a bed were used. As sorbent particles, trilobe extrudates of 1.6 mm diameter were used. Each sorbent bed had a bulk density of 750 kg/m³ and a CO₂ adsorption capacity of 0.4 mol CO₂/kg sorbent. The volume of the sorbent beds, the volume of the inlets and the volume of the outlets were all equal.

As desorption fluid, steam (120° C., 1 bara) was used.

The composition of the CO₂-enriched stream 40 at the second outlet 6 during desorption was calculated on the basis that the flow in the beds 4 themselves was plug flow and that the flow in the channels in between the beds was fully back-mixed. This will be the case in FIG. 2 as during desorption vapour is displaced from each bed at the same time along channels (in between the beds) over the full length of flow path B. This leads to efficient mixing of the vapour displaced from the beds with that in the channels in between the beds. Initially, the composition at the second outlet 6 will be essentially air that is displaced from the beds. This air is vented. Subsequently, a front of desorbed CO₂ will reach the second outlet 6. The sharpness of this front is determined by the mixing pattern of alternate plug flow and back-mixed sections as described above. At a given point (the ‘switch point’ in Table 1 below), venting is stopped and desorbed CO₂ is collected.

Table 1 below shows the overall CO₂ loss and obtained CO₂ purity when using five, ten and twenty subsequent passes (one pass representing one bed of sorbent particles).

TABLE 1

| | | |
|---|---|---|
| | | CO₂ purity of |
| | Overall CO₂ | collected |
| | loss via vent | stream after |
| | [fraction of | switch point |
| | total CO₂ | [vol. % on |
| Nr. of passes | desorbed] | dry basis] |

At 99% switch point¹

| | | |
|---|---|---|
| 5 | 0.330 | 99.90 |
| 10 | 0.233 | 99.95 |
| 20 | 0.153 | >99.95 |

At 90% switch point¹

| | | |
|---|---|---|
| 5 | 0.168 | 99.09 |
| 10 | 0.120 | 99.39 |
| 20 | 0.078 | 99.55 |

¹Represents the vol. % of CO₂ present in the CO₂-enriched stream 40 that is removed from the system via the second outlet 6 when the switch is made from venting to collection of the CO₂-enriched stream 40 at the second outlet 6.

As can be seen from Table 1, by passing a stream of steam as desorption fluid (via the second flow path B from the second inlet 5) through the plurality of adjacent beds 4 to the second outlet 6 in series) during the desorption phase, a high purity CO₂-stream is obtained (with very low air contamination), with a relatively low CO₂ loss. It can be seen from Table 1 that a CO₂ purity of above 99 vol. % (on a dry basis) is readily achieved for a system with 5 sorbent beds in series.

Even better results were obtained by passing the desorption fluid through at least 10 and at least 20 beds in series. Increasing the number of beds gives an increased CO₂ purity and a lower loss of CO₂ via the vent. As a comparison, if the same method was used for a single bed with similar inlet and outlets, a CO₂ purity of only about 50 vol. % would be achieved.

### DISCUSSION

As can be seen from Example 1, the system and process according to the present invention allows for an effective way of capturing CO₂ from a CO₂-containing stream, whilst obtaining a high purity (>99.0 vol. % on a dry basis) CO₂-stream and a low CO₂ loss (<20% of the total desorbed CO₂, preferably <10% of the total desorbed CO₂).

Further, the CO₂ purity obtained can be increased to 99.9 vol. % on a dry basis and above, by increasing the number of sorbent beds and delaying the ‘switch point’ before which the outlet stream is vented.

The person skilled in the art will readily understand that many modifications may be without departing from the scope of the invention.

1. A system for capture of carbon dioxide (CO2) from a gaseous CO2-containing stream, the system at least comprising:
a plurality of first inlets for a gaseous CO2-containing stream;
a plurality of first outlets for a treated stream having a reduced CO2-concentration compared to the gaseous CO2-containing stream;
a plurality of supported sorbent materials placed between the plurality of first inlets and the plurality of first outlets allowing a first flow path (A) therethrough for the gaseous CO2-containing stream during a CO2-adsorption phase, wherein each supported sorbent material possesses a first side that during the CO2-adsorption phase can receive the gaseous CO2-containing stream and a second side from which a treated gaseous stream having a reduced CO2-concentration can exit the supported sorbent material;
optionally, a second inlet for a desorption fluid;
a second outlet for a CO2-enriched stream;
a sealer comprising a pair of doors or plates which can close the plurality of first inlets and the plurality of first outlets during a CO2-desorption phase thereby creating a second flow path (B) for a fluid comprising desorbed CO2 through a plurality of adjacent supported sorbent materials to the second outlet from which a CO2-enriched stream can exit.

2. The system according to claim 1, wherein the supported sorbent materials comprise sorbent particles supported within a bed.

3. The system according to claim 2, wherein the supported sorbent materials have a bed depth of from 1 to 20 cm.

4. The system according to claim 1, wherein the supported sorbent materials are closed at the faces that are substantially perpendicular to the flow direction of the first flow path (A).

5. The system according to claim 1, wherein the supported sorbent materials have converging first inlets.

6. The system according to claim 5, wherein the first inlets of the supported sorbent materials are slanted.

7. The system according to claim 1, wherein the supported sorbent materials have diverging first outlets.

8. The system according to claim 7, wherein the first outlets of the supported sorbent materials are slanted.

9. The system according to claim 1, wherein the system comprises at least 5 supported sorbent materials.

10. The system according to claim 1, further comprising a filter placed upstream of the plurality of first inlets when in CO2 adsorption phase.

11. A process for capture of carbon dioxide (CO2) from a gaseous CO2-containing stream, the process at least comprising the steps of:
(a) providing a gaseous CO2-containing stream;
(b) introducing the gaseous CO2-containing stream via a plurality of first inlets;
(c) passing the gaseous CO2-containing stream via a first flow path through the supported sorbent materials to a plurality of first outlets thereby adsorbing CO2 from the CO2-containing stream;
(d) removing a treated stream from the first outlets having a reduced CO2-concentration compared to the gaseous CO2-containing stream;
(e) sealing the plurality of first inlets and first outlets with a pair of doors or plates thereby creating a second flow path (B) for a fluid comprising desorbed CO2 through a plurality of adjacent supported sorbent materials to a second outlet;
(f) desorbing the plurality of adjacent supported sorbent materials thereby releasing CO2 adsorbed to the supported sorbent materials and obtaining a CO2-enriched stream;
(g) removing the CO2-enriched stream obtained in step (f) from the second outlet.

12. The process according to claim 11, wherein the desorbing in step (f) comprises passing a stream of a desorption fluid via the second flow path (B) from a second inlet through the plurality of adjacent supported sorbent materials to the second outlet.

13. The process according to claim 11, wherein
the stream of desorption fluid in step (f) has a pressure of between 0.5-1.5 bara.

14. The process according to claim 12, wherein
the second flow path (B) during desorbing in step (f) is through at least 5 subsequent supported sorbent materials in series.

15. The process according to claim 11, wherein the desorbing in step (f) comprises heating the supported sorbent materials, preferably starting with the supported sorbent materials placed the furthest away from the second outlet, followed by supported sorbent materials placed closer to the second outlet.

16. The process according to claim 11, further comprising the steps:
(h) undoing the sealing of the plurality of first inlets and first outlets;
(i) repeating steps (a)-(h) multiple times.

17. The process according to claim 3, wherein the supported sorbent materials have a bed depth of from 1 to 20 cm.

18. The system according to claim 9, wherein the system comprises at least 10 supported sorbent materials.

19. The process according to claim 13, wherein the stream of desorption fluid in step (f) has a pressure of between 0.9-1.1 bara.

20. The process according to claim 14, wherein the second flow path (B) during desorbing in step (f) is through at least 10 subsequent supported sorbent materials in series.
